(19) United States
(12) Patent Application Publication
(10) Pub. No.: US 2008/0099556 A1
(43) Pub. Date: May 1, 2008

(54) Card Having Password Input Key

(76) Inventor: Jung Woong Park, Yongin-si (KR)

Correspondence Address: Hyun Jong Park;Tuchman & Park LLC, 41 White Birch Road, Redding, CT, 06896-2209, US

(21) Appl. No.: 11/875,873

(22) Filed: Oct. 20, 2007

(30) Foreign Application Priority Data
Aug. 9, 2007 (KR) PCT/KR07/03829
Aug. 9, 2006 (KR) 2006-0075053
Sep. 1, 2006 (KR) 2006-0084037

(51) Int. Cl. G06K 19/073; G06K 7/01

(52) U.S. Cl. 235/382.5; 235/492; 235/493

(57) ABSTRACT

The present invention provides a card having password input keys, which can prevent duplication of a credit card, a cash card, or an electronic identification card by a unauthorized third party upon loss or theft of the card, and which is constructed so that a separate password, other than a password for card payment assigned when the card is issued, is set in the card, and a magnetic stripe card or smart card-type credit card, cash card or electronic identification card can be turned on/off when a correct password is input, thus implementing a plurality of security functions without requiring changes to be made to a conventional card terminal or various operating systems.

### REFERENCE TO RELATED APPLICATIONS

This is a continuation of pending International Patent Application PCT/KR2007/003829 filed on Aug. 9, 2007, which designates the United States and claims priority of Korean Patent Application No. 2006-0075053, filed on Aug. 9, 2006, and Korean Patent Application No. 2006-0084037, filed on Sep. 1, 2006, the entire contents of which are incorporated herein by reference.

### FIELD OF THE INVENTION

The present invention relates, in general, to a password input key and, more particularly, to a card having password input keys, which can allow a password set in a card itself to be input using a small number of input keys, can confirm a card verification value, a one-time password, information about a card holder, etc. only when a correct password is input, can prevent the repeated use of the card, and can give notice of crimes, such as unauthorized cash withdrawal stemming from kidnapping.

### BACKGROUND OF THE INVENTION

Methods for preventing the illegal use or misappropriation of various credit cards, gift cards, cash cards, and electronic Identification (ID) cards may include a method of providing a plurality of input keys on a single card and inputting a password using the input keys, as an example. The card has a structural restriction and has a high probability of malfunctioning when used, because input keys are installed on the surface of the card.

As shown in FIG. 1, in the case of a credit card 100, an International Standards Organization (ISO) specification has been defined so that the area of the surface of a card is about 85 mm×53 mm, and the thickness thereof is 0.8 mm or less. Typically, on the card, the name of the card company, the name of an affiliated company, a logo, a trademark, a hologram, and information about the name of the card holder, the card number, the expiration date, etc., which are marked as embossed characters required for printing slips, are provided thereon. Further, in the case of a traffic card or a contactless card, an internal chip, an antenna, etc. are additionally provided therein. Accordingly, there is insufficient space for the installation of 10 input keys 101, corresponding to the numbers 0 to 9, and a plurality of function keys 102 on the surface of the card.

Therefore, when 10 input keys 101 and the plurality of function keys 102 are densely arranged in a small limited space on the surface of the card 100, it is very difficult to individually precisely press each fine key using the tip of the finger of an adult, thus errors of pressing the incorrect number key, or simultaneously pressing two upper and lower number keys or two right and left number keys may easily occur. Further, since the number of input keys 101 is 10, and the number of function keys 102 is more than one, it is impossible to use the card even if a problem occurs only on a single contact point among the keys, thus increasing the probability that a card will become nonfunctional.

As described above, a credit card 200 for solving the problem of a usable PC space required to install 10 input keys on the surface of a card (disclosed in Korean Patent Registration No. 10-0476876) has a structure in which input keys are arranged in a line on the lower edge of the card 200, as shown in FIG. 2. The overall thickness of the credit card 200 is about 0.8 mm, and a space, required to install contact points for 10 push-type switches 101 and 102 between the upper and lower protective outer layers within a thickness of about 0.8 mm, is limited to 0.6 mm or less, excluding the surface layers on both sides of the card, thus the credit card has an extremely fine mechanical structure.

Therefore, since the conventional credit card 200 has a high probability of being damaged when slight bending or twisting occurs during the typical usage or storage of the card by consumers, and requires high technology in parts thereof or in the manufacturing process thereof, there are many obstacles preventing the use of the credit card.

A conventional credit card, including the above credit card, has a Card Verification Value (CVV) which can be used for security in online transactions.

Typically, online payment using credit cards through a phone or computer is performed by verifying or inputting only the name of a credit card holder, the name of the card company, the card number, and the expiration date, which appear on the credit card, and a CVV printed in a signature panel on the back of the credit card. Since information required to conduct online payment using a credit card is printed on the surface of the credit card in this way, anyone can illegally make payments using a credit card acquired through loss, theft, or forgery, other than the rightful owner of the card, without any restrictions.

Further, in the prior art, a password is used to improve security when a financial transaction is conducted using a credit card. In this case, there is the risk of the password being exposed because the password, once assigned, is repeatedly used.

In order to overcome the risk, a one-time password adoption method of issuing a random number table card, in which several number groups, such as A group, B group, C group, and D group, each composed of four digits or six digits, are listed, or storing the random number table card in a computer, creating a combined number using numbers selected from two or more groups, differently and arbitrarily designated whenever payment is processed, and utilizing the combined number as a password, has been adopted.

For example, a password can be a four-digit number group, which is obtained by combining the first two digits selected from the A group with the latter two digits selected from the C group.

However, in this case, when the random number table card is lost or when a random number table stored in the computer is hacked, a person who illegally acquired the card can also create a One-Time Password (OTP) in compliance with a command, thus the original holder of the random number table card is exposed to risk without defense.

Further, in service trade places, such as a gas station, a restaurant or an entertainment place, an employee takes a credit card from a customer, brings the credit card to a card terminal located in another place out of sight of the customer, and completes payment, so that, if the employee illegally duplicates the credit card or repeatedly uses the credit card, the customer is not aware of the fact.

Further, there frequently occurs the case where victims have their credit cards stolen, inform their assailant of a password, and allow their money to be withdrawn, in crimes related to credit cards, that is, in threatening situations, such as kidnapping, hostage-taking or confinement. In this case, since the assailant victimizes the victims for fear of future consequences, or releases the victims after a considerable time period has elapsed in order to secure the time for an escape, prompt identification of the victims and detection of criminals, which are absolutely important points in order to ensure the victims' safety and solve the crime, are difficult.

Further, in the case of various identification cards, such as a resident card, a driver's license or a passport, if an illegal user changes the original photograph to another photograph and carefully attaches the photograph, as is seen in frequently occurring forgery crimes, it is impossible to identify, in a predetermined place, whether an illegal user who presents the identification card is the rightful user, using an address, a name, a birth date, an identification card number, etc. which are printed on the surface of the identification card.

### SUMMARY OF THE INVENTION

Accordingly, the present invention has been made keeping in mind the above problems occurring in the prior art, and an object of the present invention is to provide a card having password input keys, in which four input keys are formed on the card itself, and which enables a password, for turning on/off a magnetic stripe card-type or smart card-type credit card or cash card, to be input using only the four input keys, which have the function of selecting functionality or numbers and deleting incorrect numbers, thus making the use of various types of cards convenient, reducing the complexity of the manufacturing process and the cost of cards, and minimizing error in the manipulation of the cards.

Another object of the present invention is to provide a card having password input keys, in which a Card Verification Value (CVV), or a Card Validation Code (CVC) is stored in a microprocessor chip in the card without being printed on the surface of the card, and is displayed in a display panel on the surface of the card only when the rightful card holder inputs his or her set password by pressing the input keys installed on the card itself, so that the CVV or CVC displayed in the display panel is input as a card verification value for credit card payment, thus preventing illegal online payment using stolen, lost or duplicated cards.

A further object of the present invention is to provide a card having password input keys, in which a random number table, including several number groups, such as A group, B group, C group and D group, is stored in a microprocessor chip in the card, and a one-time password, created through a combination of numbers selected from the several number groups, is displayed in the display panel on the surface of the card only when the rightful card holder inputs his or her set password by pressing the input keys installed on the card itself, so that the OTP displayed in the display panel is input as an OTP for payment in financial transactions using a card, thus strengthening security.

Yet another object of the present invention is to provide a card having password input keys, which is constructed so that, if a credit card, which is turned on through the input of a password, is used once in a payment terminal, the credit card is automatically turned off, thus preventing the credit card from being read and illegally duplicated using a card duplicator, or from being repeatedly used in a gas station, a restaurant or a an entertainment place.

Still another object of the present invention is to provide a card having password input keys, which is operated so that, when a card holder is forced to inform an assailant of the password of the card and has his or her money forcibly taken due to mugging in a dangerous situation, such as kidnapping or hostage-taking, the card holder informs the assailant of a number, obtained by attaching a previously programmed one-digit or two-digit emergency number to the password enabling the withdrawal of money, thus enabling a card company control center or other law enforcement agencies to be aware of the identity of the victim, the amount of damage, the location where money was withdrawn, and the time at which the crime occurred when the emergency number is input, and to quickly respond to the crime in order to promptly solve the crime.

Still another object of the present invention is to provide a card having password input keys, in which text information, such as a birth date, an address, or an identification card number, is only stored in a microprocessor chip in an identification card, such as a resident card, a driver's license, or a passport, without being printed on the surface of the identification card, and in which image information, such as a photograph or fingerprints, is attached to the surface of the card so that the image information is hidden by an Electrochromic Display (ECD) screen or by other equivalent means, which is transparent or opaque according to the flow of current, and is not visible at normal times, and information, such as a birth date, an address, an identification card number, and a photograph, is displayed in the display panel on the surface of the identification card only when the rightful card holder inputs his or her set password by pressing the input keys installed on the identification card itself, thereby determining whether the holder of the corresponding identification card is the rightful user, and consequently preventing illegitimate users from illegally utilizing an identification card belonging to a third party, or a forged identification card.

In order to accomplish the above objects, one aspect of the present invention provides a card having password input keys, comprising an input key unit including input keys formed on an edge or a surface of the card, and adapted to turn on/off power of the card, select various functions, and increment or decrement a number; a main IC chip for interfacing with a smart card terminal; a controller for storing a password input through manipulation of the input key unit, and outputting a control signal for activating the main IC chip when the stored password is identical to a password input through manipulation of the input key unit for usage of the card; a switch turned on/off under the control of the controller to connect the controller to the main IC chip, thus activating the main IC chip and an internal thin film battery for supplying power to drive the controller.

Further, one aspect of the present invention provides a card having password input keys, comprising an input key unit including input keys formed on an edge or a surface of the card, and adapted to turn on/off power of the card, select various functions, and increment or decrement a number; a magnetic stripe unit for storing data information about the card; a thin film permanent magnet; a controller for storing a password input through manipulation of the input key unit, and outputting a control signal for activating the magnetic stripe unit when the stored password is identical to a password input through manipulation of the input key unit for usage of the card; a switch turned on/off under the control of the controller to connect the thin film permanent magnet to the magnetic stripe unit, thus activating the magnetic stripe unit and an internal thin film battery for supplying power to drive the controller.

Preferably, a smart card or a magnetic stripe card may be designed so that a code or a signal on an main IC chip or magnetic stripe for activating an emergency alarm is set in the main IC chip or magnetic stripe unit, and the controller may be operated so that, if a signal requesting transmission of an emergency signal is input together with the password, through manipulation of the input key unit, the controller activates the main IC chip or magnetic stripe unit, including the magnetic stripe or the code or the signal in the main IC chip for activating the emergency alarm, thus notifying a payment center of illegal cash withdrawal stemming from kidnapping, hostage-taking or mugging.

Preferably, the card may further comprise a sensor adapted to sense a signal of a magnetic stripe card terminal or a smart card terminal and connected to the controller, the controller being operated such that, if the card, which is turned on through input of a password identical to the preset password, is passed through the magnetic stripe card terminal or the smart card terminal once, the controller releases the card from the turned-on state, thus preventing repeated payment using the card and duplication of the card.

Further, one aspect of the present invention provides a card having password input keys, comprising an input key unit including input keys formed on an edge or a surface of the card, and adapted to turn on/off power of the card, select various functions, and increment or decrement a number; a controller for storing a Card Verification Value (CVV) for identifying whether a user is a rightful holder of the card in an online transaction, together with a password input through manipulation of the input key unit, and outputting a control signal for displaying the CVV when the stored password is identical to a password input through manipulation of the input key unit for usage of the card; a display panel driven under control of the controller and adapted to show a power state of the card or an input state of the input key unit, and the CVV, stored in the controller, to the user; and an internal thin film battery for supplying power to drive the controller.

Further, one aspect of the present invention provides a card having password input keys, comprising an input key unit including input keys formed on an edge or a surface of the card, and adapted to turn on/off power of the card, select various functions, and increment or decrement a number; a controller for storing a plurality of number groups required to create a one-time password for security in a financial transaction through combination of numbers, together with a password input through manipulation of the input key unit, and outputting a control signal for displaying the plurality of number groups when the stored password is identical to a password input through manipulation of the input key unit for usage of the card; a display panel driven under control of the controller and adapted to show a power state of the card or an input state of the input key unit, and the plurality of number groups, stored in the controller, to the user; and an internal thin film battery for supplying power to drive the controller.

Further, one aspect of the present invention provides a card having password input keys, comprising an input key unit including input keys formed on an edge or a surface of the card, and adapted to turn on/off power of the card, select various functions, and increment or decrement a number; a controller for storing a unique identification code of the card, a name or resident registration number, together with a password input through manipulation of the input key unit, and outputting a control signal for displaying the unique identification code of the card, the name, or the resident registration number when the stored password is identical to a password input through manipulation of the input key unit; a display panel driven under control of the controller and adapted to show a power state of the card or an input state of the input key unit, and the unique identification code, the name, or the resident registration number, stored in the controller, to the user; and an internal thin film battery for supplying power to drive the controller.

Further, one aspect of the present invention provides a card having password input keys, comprising an input key unit including input keys formed on an edge or a surface of the card, and adapted to turn on/off power of the card, select various functions, and increment or decrement a number; a controller for causing a photograph of a holder of a card or an identification card to be attached to a surface of the card while storing a password input through manipulation of the input key unit, and for outputting a control signal for displaying visual information such as the photograph of the holder of the card or the identification card so that the photograph is hidden by an Electrochromic Display (ECD) screen or other equivalent method, which is opaque when current does not flow, and is not visible at normal times, and the photograph is visible when power is supplied to the ECD screen to cause the ECD screen to be transparent if the stored password is identical to a password input through manipulation of the input key unit; the ECD screen maintained in an opaque state because current does not flow if a correct password is not input through manipulation of the input key unit, and changed from the opaque state to a transparent state because current flows under the control of the controller if the correct password is input through manipulation of the input key unit, thus enabling the photograph of the holder of the card or the identification card to be viewed; and an internal thin film battery for supplying power to drive the controller and the ECD screen.

Preferably, the input key unit may comprise a function key for turning on/off power of the card and setting a number displayed in the display panel, up key, down key for incrementing or decrementing a number displayed in the display panel, and a change/delete key for changing or deleting a number displayed in the display panel.

Preferably, each key of the input key unit may be a tactile switch or a capacitive membrane switch.

As described above, one aspect of the present invention provides a card, which is designed to set a password in the card itself, such as a credit card, a cash card, or various electronic identification cards, and to input the set password using only four input keys, thus simplifying the arrangement and design of input keys, and the manipulation of input keys. Consequently, the present invention can greatly eliminate a complicated manufacturing process and high manufacturing cost, which may occur when a plurality of input keys is installed due to the limited thickness and area of a credit card, as defined in the ISO specification. Further, the card is advantageous in that the use of the card by a customer is convenient, and the structure, installation location and operation method for the input keys are improved. Consequently, security against loss, damage, or crimes using forged cards can be improved while the probability of damage or defects caused by erroneous input, erroneous operation, bending or twisting in normal use and storage state of the card can be minimized.

Further, one aspect of the present invention is advantageous in that a card verification value (CVV) for identifying a user is stored in a card without being visible at normal times, and is visible in a display panel on the surface of the card only when the rightful card holder inputs the correct password, thus preventing online crimes using the third party's card.

Further, one aspect of the present invention is advantageous in that, in the case of an electronic identification card, such as a resident registration card, the name and resident registration number of a card holder, a unique identification code, fingerprints, a photograph, etc., which are stored in the card or attached to (printed on) the surface of the card, are not visible at normal times, and appear in the display panel on the surface of the card or through a transparent ECD screen only when a correct password is input, thus preventing various crimes using the other party's identification card. Further, since the identification card can be turned on and presented without requiring a card terminal, the card can be efficiently used even in predetermined place in which the carrying of the terminal is difficult.

Further, one aspect of the present invention is advantageous in that a kind of random number table, composed of a plurality of number groups for creating a password typically required for online financial transactions using cards, is stored in the card, and appears in the display panel on the surface of the card only when a correct password is input, so that a kind of Virtual One-Time Password (VOTP), which varies each time depending on the guidance of a number combination method provided by a payment center, is output and used, thus eliminating the inconvenience of a conventional random number table card system, which is liable to be lost and is inconvenient to carry, or a conventional system, which must capture and use an OTP, which varies every time, and thus improving security during an online financial transaction using a card.

Further, one aspect of the present invention is advantageous in that an emergency number for indicating a crime related to cash withdrawal or blackmailing in threatening situations, such as the kidnapping of a victim, hostage-taking, or mugging, can be input into the card, together with a normal password, and notification of an emergency situation is provided to a payment center when the emergency number is input together with the password, thus recognizing the place and time at which a crime occurred, the identity of the victim, etc. in real time, and quickly responding to the crime to solve the crime.

Further, one aspect of the present invention is advantageous in that, in the case of a card which is turned on and is in a usable state when a password identical to a password preset in the card itself is input, if the card is used in a card terminal once, the card is automatically switched to an off state, thus preventing illegal use, such as repeated payment or the duplication of the card using a card duplicator, that may occur when an employ takes the card from a customer, moves to a place out of sight of the customer, and completes payment using a card terminal in a gas station or restaurant.

### BRIEF DESCRIPTION OF THE DRAWINGS

FIG. 1 is a diagram showing an example of a conventional credit card;

FIG. 2 is a diagram showing another example of a conventional credit card; and

FIGS. 3 to 6 are diagrams showing a plurality of embodiments of a card according to the present invention.

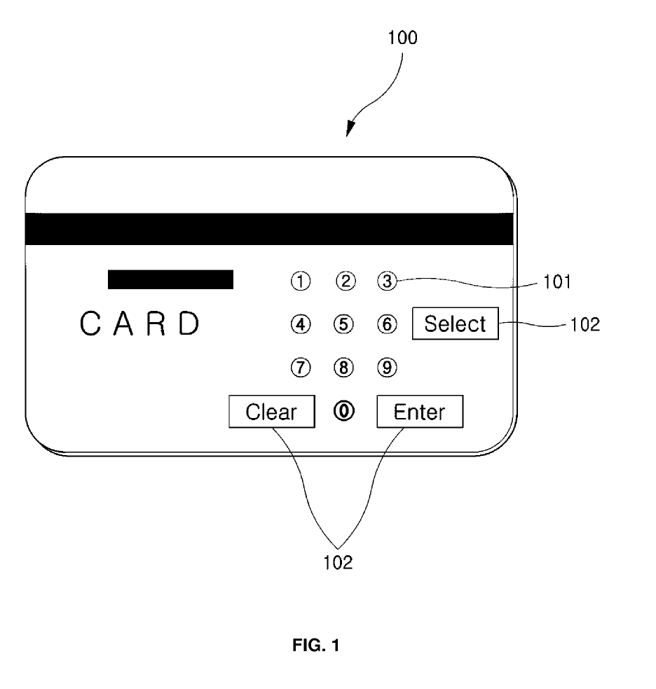

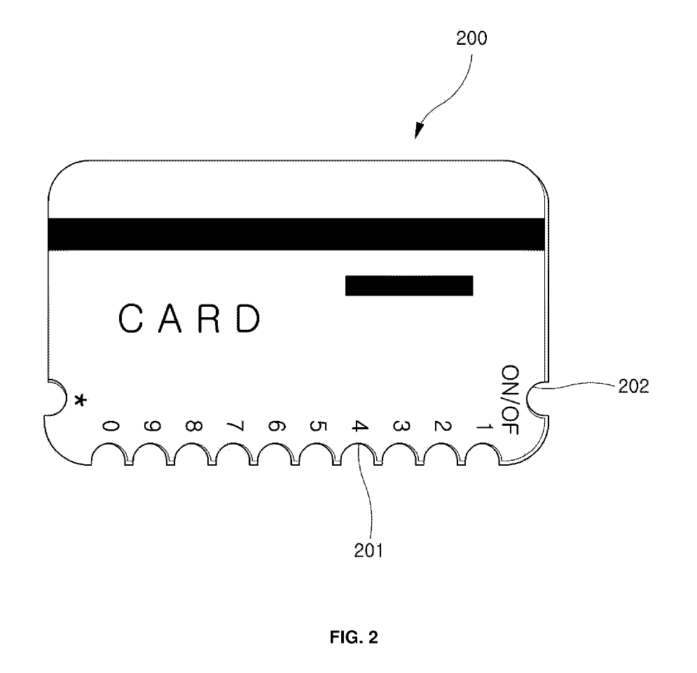

### DESCRIPTION FOR SOME REFERENCE NUMERALS OF THE DRAWINGS

1: card
10: controller
11: switch
12: internal thin film battery
13: display panel
14a: main IC chip
14b: magnetic stripe unit
15: permanent magnet
16, 17: input key unit
16a, 17a: function key
16b, 16d, 17b, 17d: up/down key
16c, 17c: change/delete key
18: ECD screen

### DETAILED DESCRIPTION OF THE INVENTION

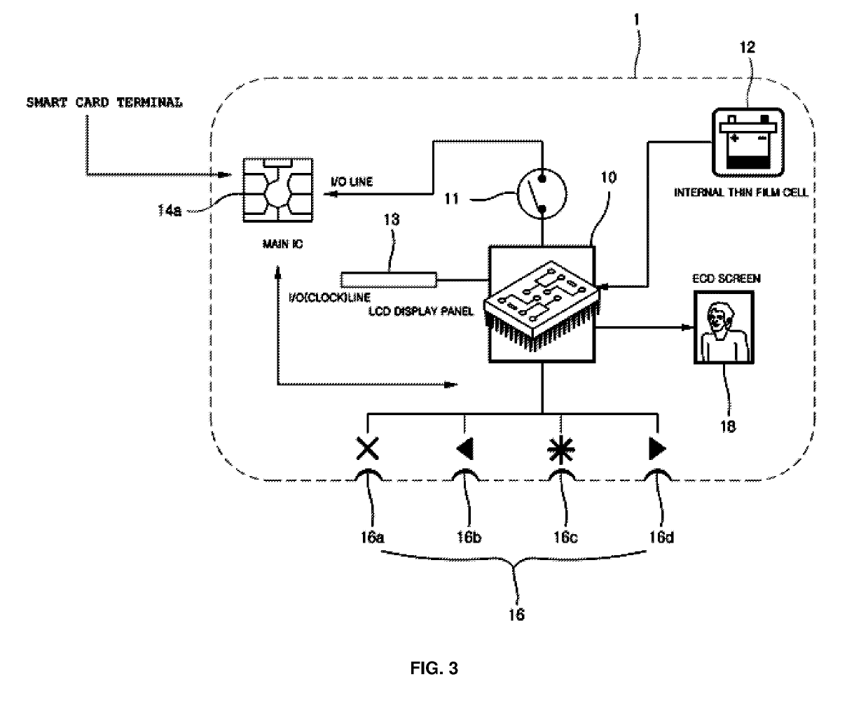

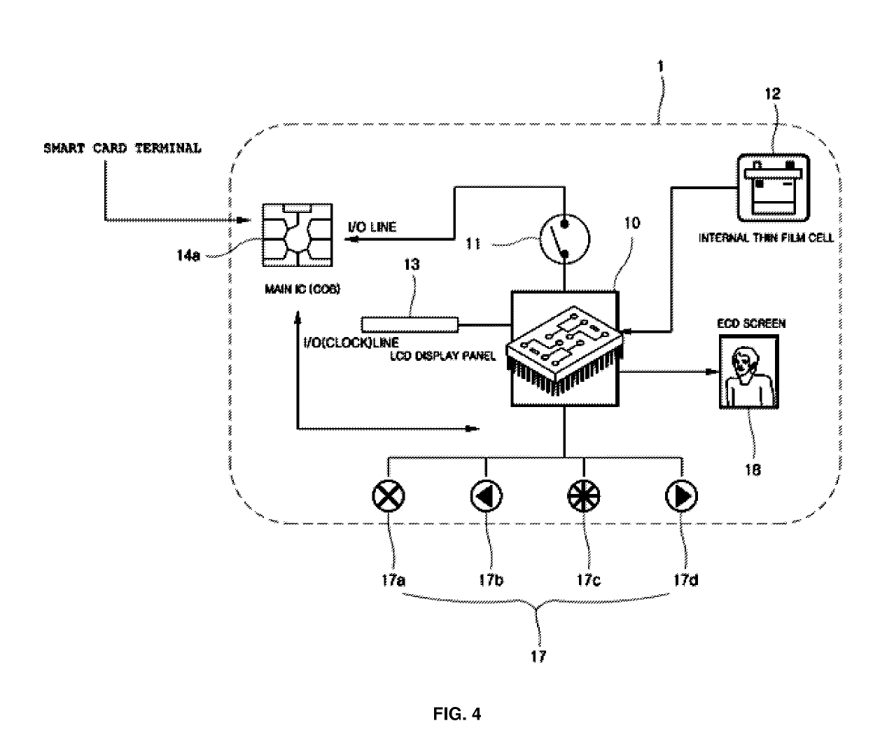

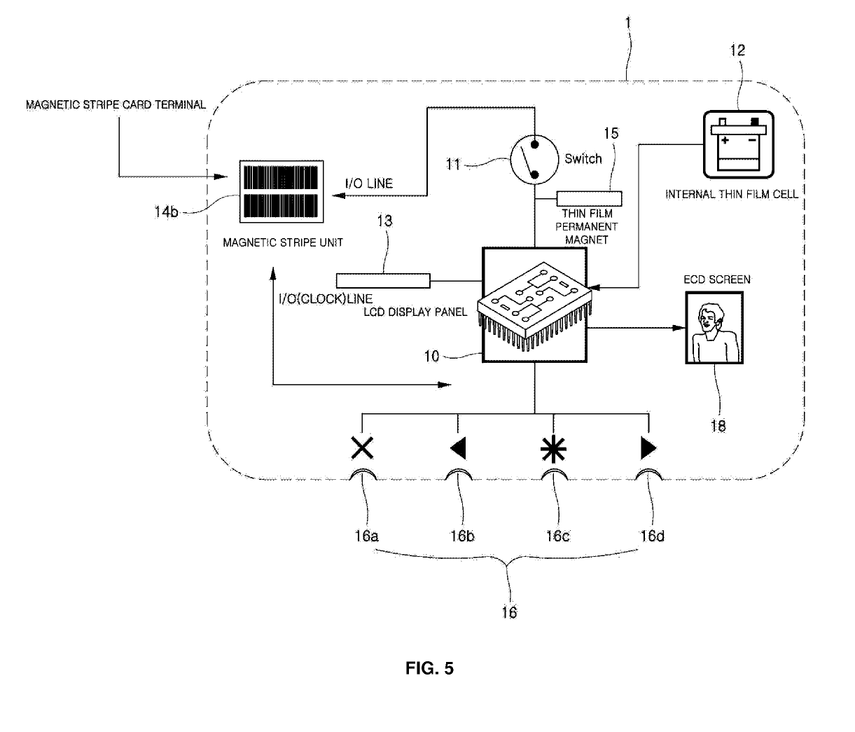

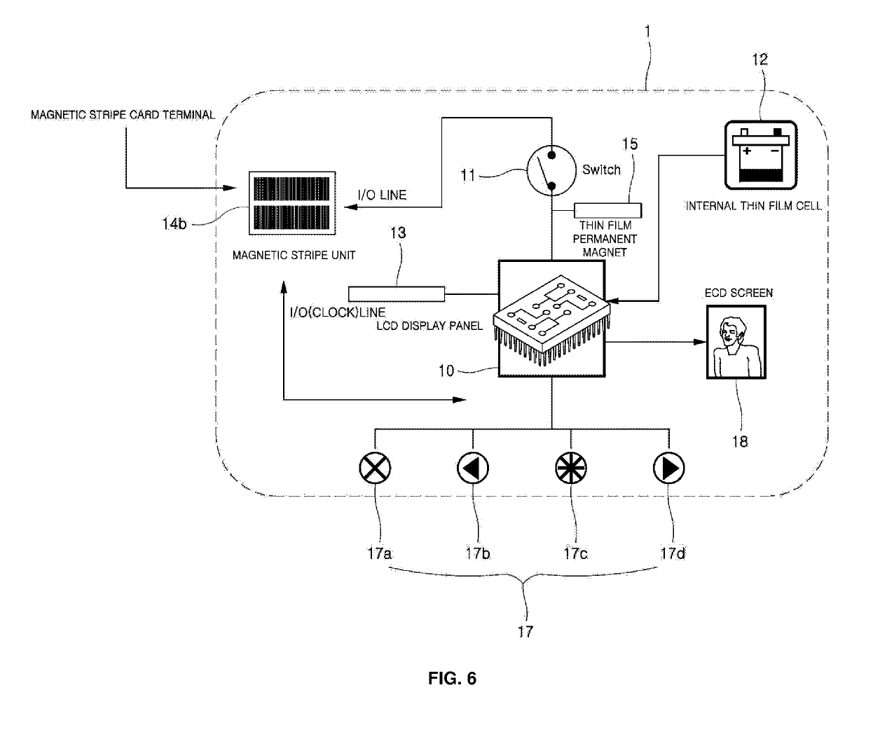

FIGS. 3 to 6 are diagrams showing various embodiments of a card according to the present invention. FIGS. 3 and 4 illustrate smart cards usable for a smart card terminal, and FIGS. 5 and 6 illustrate magnetic stripe cards usable for a magnetic stripe card terminal.

A controller 10 for controlling the overall operation of a card 1, which is used as a credit card or a cash card, or various electronic identification cards, is connected to an input key unit 16 composed of four push-type input keys 16a to 16d installed in the lower edge of the card 1, as shown in FIGS. 3 and 5, or to an input key unit 17 composed of four tactile input keys 17a to 17d installed on the surface of the lower end of the card 1, as shown in FIGS. 4 and 6. The input keys of the input key unit 16 or 17 are tactile switches or capacitive membrane switches, and can be installed on the surface of the lower end or side end of the card 1, or the lower edge or side edge of the card 1.

In this case, the input key unit 16 or 17 of the card 1 includes four keys, including a function key 16a or 17a, in which special operation input functions are combined in a single key, a change/cancel key 16c or 17c, and up/down keys 16b or 17b and 16d or 17d enabling numbers to be displayed in a display panel 13 while incrementing a number in ascending order of 1, 2, 3, . . . , 0 or decrementing a number in descending order of 0, 9, 8, . . . , 1 whenever the key is pressed.

The controller 10 has different programs installed therein depending on the usage of the card 1, or depending on whether a main IC chip 14a or a magnetic stripe unit 14b is connected, and controls the driving of a switch 11, the display panel 13, and the main IC chip 14a or the magnetic stripe unit 14b depending on the manipulated state of the input key unit 16 or 17. Further, the controller 10 can selectively store therein a password, a card verification value, a plurality of number groups, an emergency number, other unique numbers for identifying a user, etc. depending on the purpose of the card 1.

In the figures representing the embodiments of the present invention, though the controller 10 and the main IC chip 14a are different parts, they may be integrated in a body or in an IC chip. In that case, switch 11 naturally included in the IC chip. The controller and the main IC chip may be connected by more than one buses or connection lines that have their own switch.

An internal thin film battery 12 connected to the controller 10 supplies driving power to the controller 10, the switch 11, and the display panel 13, and can be implemented using a solar cell, etc. The switch 11 is driven under the control of the controller 10, and functions to electrically connect the controller 10 to the main IC chip 14a in FIGS. 3 and 4, and to connect a permanent magnet 15 to the whole magnetic stripe or some part of the whole magnetic stripe in the magnetic stripe unit 14b in FIGS. 5 and 6.

The permanent magnet 15 may be located near the magnetic stripe unit 14b to give magnetic field to the magnetic stripe unit 14b easily. Instead of the permanent magnet 15, magnetic field induced by current may be used to activating the magnetic stripe unit 14b. It is also possible that only some part of the whole magnetic stripes in the magnetic stripe unit 14b may be activated by the above mentioned method and other stripes are always have some magnetism to execute their own functions.

Further, the LCD display panel 13 functions to display a password input through the manipulation of the input key unit 16 or 17, or other information required for the user (holder) of the card 1, under the control of the controller 10.

In particular, when the card 1 is used as a credit card, a cash card, or a debit card, or various types of electronic identification cards, the LCD display panel 13 as shown in FIG. 3 to 6 displays a password input through the manipulation of the input key unit 16 or 17, or other information required for the user (holder) of the card 1 under the control of the controller 10, and also displays the name or resident registration number of the holder of the card 1. An Electrochromic Display (ECD) screen 18 functions to display various types of information required to identify the holder of the card 1, such as the photograph or fingerprints of the card holder.

In this case, the ECD screen 18 is a device which is installed on top of image information, such as fingerprints or a photograph attached to or printed on the surface of the card, and which changes from an opaque state to a transparent state using power supplied from the internal thin film battery 12 under the control of the controller 10, having recognized the manipulation of the input key unit 16 or 17, thus enabling the photograph or fingerprint to be viewed.

Hereinafter, a detailed embodiment, in which the controller 10 controls various driving operations for the card 1 using the programs installed in the controller 10, is not described, but only a method of manipulating the input key unit 16 or 17 and a method of inputting numbers by manipulating the input key unit 16 or 17 will be described in detail.

### EMBODIMENT 1

### Method of Inputting and Using Simplified Password

First, if the function key 16a or 17a is pressed for a long time (about 3 seconds), the power of the card 1 is turned on under the control of the controller 10, and the number ‘1’ is displayed in the display panel 13.

In order to input a password to a newly issued card 1 in a password reset state (in this example, the password is ‘2573’), if a user turns on the power of the card 1 by pressing the function key 16a or 17a, causes a number ‘2’ to be displayed in the display panel 13 by manipulating the up/down keys 16b or 17b and 16d or 17d, and then briefly presses the function key 16a or 17a, a rectangular frame is formed around the number ‘2’, or shading is represented behind the number ‘2’ as a confirmation indication by the controller 10, thus the number ‘2’ is set.

Further, in order to set the number ‘5’, the user causes the number ‘5’ to be displayed in the display panel 13 by pressing the up/down keys 16b or 17b and 16d or 17d in a state in which a cursor is placed in the column next to the number ‘2’, which has been set in the display panel 13, and briefly presses the function key 16a or 17a to perform a confirm indication, thus the number ‘5’ is set.

Further, with respect to the remaining numbers ‘7’ and ‘3’, the user finds corresponding numbers by pressing the up/down keys 16b or 17b and 16d or 17d, similar to the above method, and thus confirms and sets the corresponding numbers by manipulating the function key 16a or 17a.

If the function key 16a or 17a is pressed, the desired password ‘2573’ is input again using the same method as the above method while the password ‘2573’, desired to be input, is displayed in the display panel 13 in this way, and then the function key 16a or 17a is pressed, the password ‘2573’, which only the user knows, is stored in the controller 10.

If the password ‘2573’ input first is identical to the password ‘2573’, input again to confirm the password, a message, indicating that the two passwords are identical to each other (for example, the message ‘OK’), is displayed in the display panel 13 while the password ‘2573’ displayed in the display panel 13 disappears.

Next, in order to turn on the card 1, if the password ‘2573’ is input by manipulating the input key unit 16 or 17, a message ‘OK’, indicating that the card 1 can be used, is displayed in the display panel 13 after the input password ‘2573’ is displayed in the display panel 13 for 2 to 3 seconds and then disappears.

As described above, if the message ‘OK’, indicating that the card 1 can be used, is displayed in the display panel 13, the controller 10 turns on the switch 11 to electrically connect the main IC chip 14a to the controller 10, and thus activates the main IC chip 14a, in the case of the smart card-type card 1, as shown in FIGS. 3 and 4, and turns on the switch 11 to connect the thin film permanent magnet 15 to the magnetic stripe unit 14b, and thus activates the magnetic stripe unit 14b, in the case of the magnetic stripe card-type card 1, as shown in FIGS. 5 and 6.

Therefore, a smart card terminal or magnetic stripe card terminal (not shown) can read information about the card 1, recorded in the activated main IC chip 14a or the activated magnetic stripe unit 14b of the card 1.

In this case, if the password ‘2573’ set by the user is not identical to a password input to use the card 1, the message ‘ERROR’, indicating that a wrong password was input, is displayed in the display panel 13 for 2 to 3 seconds while blinking, and then disappears, and the card 1 returns to an initial state while the number ‘1’ is displayed in the display panel 13.

Further, the card 1 is preferably constructed so that, if the incorrect password is input a certain number of times (for example, about five times), the card 1 temporarily does not support the function of inputting a password, and then supports the function again after a certain period of time (for example, one hour) has elapsed, thus preventing a person who has illegally acquired the corresponding card from easily detecting the password.

Further, in the input key unit 16 or 17, the change/delete key 16c or 17c can be implemented to not only delete the number that is currently being input during an operation of inputting numbers, but also turn off the power of the card 1 by pressing the change/delete key 16c or 17c for a long time until the message ‘OK’, indicating that the card 1 can be used, disappears from the display panel 13.

Of course, the card 1 can be implemented so that the power thereof is turned off after a certain period of time (for example, 2 to 5 minutes) has elapsed from the time point at which the message ‘OK’, indicating that the card 1 can be used, is displayed in the display panel 13.

In this case, if a password identical to the previously stored password is input, information identifying the card holder, such as a photograph or fingerprints, which is attached to the surface of the card 1, but was hidden by the ECD screen 18, which is opaque when current does not flow, and was not visible, is visible through the ECD screen 18 when the ECD screen 18 becomes transparent as the power is turned on, under the control of the controller 10, thus the identity of the holder of the card 1 can be correctly verified.

In this case, when the password set in the card 1 is intended to be changed, the user can press the function key 16a or 17a a certain number of times (for example, five times) to display the number ‘1’ in the display panel 13, and then input a new password using the above-described method. Further, when the set password is forgotten, the user can personally visit the company issuing the card 1 to be identified, after which the card 1 is reset.

### EMBODIMENT 2

### Method of Storing and Displaying Card Verification Value in Display Panel

A card verification value to be input when an online transaction is performed through a phone or the Internet is stored in the controller 10 or memory connected thereto rather than being printed on the surface of the card 1. Of course, the card 1 is constructed so that a separate password is set, as in the case of the embodiment 1, and the card 1 enters a state in which the power thereof is turned on, that is, a state in which the card 1 can be used, when a password identical to the preset password is input.

Therefore, if the password identical to the preset password is input through the manipulation of the input key unit 16 or 17, the message ‘OK’, indicating that the card 1 can be used, is displayed in the display panel 13. Then, if the function key 16a or 17a is briefly pressed twice, a card verification value is displayed in the display panel 13 for 3 to 5 seconds, so that the holder of the card 1 can perform an online transaction through a phone or the Internet using the card verification value displayed in the display panel 13.

If such a method is applied to various electronic identification cards, it is possible to check an identification card and to identify whether the holder of the identification card is the rightful user in a predetermined place without requiring a terminal, because a resident registration number, a unique identification code, the name of a card holder, etc., rather than a card verification value, are stored in the controller 10 or memory connected thereto, thus preventing the third party from illegally using the identification card, and thus improving security.

Even in this case, the card 1 is constructed so that a separate password is set, as in the case of the embodiment 1, and the power of the card 1 is turned on when a password identical to the preset password is input.

Therefore, if a password identical to the preset password is input through the manipulation of the input key unit 16 or 17, the name or the resident registration number of the holder of the card 1, the unique identification code of the card 1, etc. are displayed in the display panel 13, so that it is possible to identify whether the holder of the identification card is the rightful user in a predetermined place without requiring a terminal, thus preventing the occurrence of crimes using a third party's identification card or a forged or altered identification card.

Furthermore, the present invention is constructed so that, if a password identical to the previously stored password is input, information identifying the holder of the card 1, such as a photograph or fingerprints, which is attached to the surface of the card 1, but was hidden by the ECD screen 18, which is opaque when current does not flow, and was not visible, is visible through the ECD screen 18 when the ECD screen 18 becomes transparent as the power is turned on, under the control of the controller 10, thus the identity of the holder of the card 1 can be verified. Accordingly, illegal use of the card or identification card can be prevented.

The card according to the above-described embodiment 2 need not have a switch 11, a permanent magnet 15, a main IC chip 14a, or a magnetic stripe unit 14b, unlike the embodiment 1.

### EMBODIMENT 3

### Method of Storing and Displaying One-Time Password in Display Panel

Four or six number groups required to create a one-time password, which is to be input when an online financial transaction is conducted through a phone or the Internet, through combination of numbers are provided, with the number groups stored in the controller 10 or memory connected thereto when a card issuing company issues the card, without being provided with the number groups printed on a separate paper.

For example, several number groups may be, for example, A: 48-25, B: 36-23, C: 78-49, and D: 85-27.

Of course, even in this case, the card 1 is constructed so that a separate password is set, similar to the above embodiments, and the card 1 enters a state in which the power thereof is turned on, that is, a state in which the card 1 can be used, when a password identical to the preset password is input.

Therefore, if a password identical to the preset password is input through the manipulation of the input key unit 16 or 17, a message ‘OK’, indicating that the card 1 can be used, is displayed in the display panel 13. Then, if the function key 16a or 17a is briefly pressed three times, a card verification value is displayed in the display panel 13 for 3 to 5 seconds, so that the holder of the card 1 can create a one-time password (OTP) by combining numbers corresponding to four digits with each other while viewing the several number groups displayed in the display panel 13, through a method differently required each time by an online payment center, and can use the OTP for online payment.

For example, if the online payment center gives a command ‘please input the number obtained by combining the first number in the A group with the last number in the C group’, the holder of the card 1 need only input an OPT ‘4849’ obtained by combining the first number 48 in numbers 48-25 in the A group with the last number 49 in numbers 78-49 in the C group.

This method can use 8 combination elements. If the reverse order arrangement of numbers is also taken into consideration, a total of 256 different 4-digit numbers can be created as the OTP through combinations of numbers.

### EMBODIMENT 4

### Method of Preventing Repeated Use of Card

A card 1 for preventing the repeated use thereof is similar to the above embodiment 1 in that a separate password is stored in the card 1, and the card 1 can be used only when the corresponding password is input.

However, the card 1 is characterized in that, in the case of payment out of sight of the customer, in which an employee takes the card 1 from a customer, who remains in place, and completes the payment in another place out of sight of the customer in service trade places, such as a gas station, a restaurant, or an entertainment place, the card 1 is immediately released from the usable state when passed through a card terminal once in order to prevent repeated payment, other than original payment, or the duplication of the card using a card duplicator.

This construction is suitable for application to a magnetic stripe card-type card. A current signal, excited in a head for reading a magnetic signal from a magnetic stripe card terminal when the magnetic stripe unit 14b is passed through the head, is sensed by a current sensor connected to the controller 10 of the card 1, so that the card 1 is released from the usable state after a certain period of time (for example, 1 to 2 seconds) has elapsed, thus preventing the illegal and repeated use of the card.

### EMBODIMENT 5

### Method of Making Provisions Against Forced Cash Withdrawal in Threatening Situations, Such as Kidnapping or Hostage-Taking

This card 1 is suitable for both a smart card and a magnetic stripe card-type card, and is similar to the embodiment 1 in that a separate password is stored in the card 1 and can be used only when the corresponding password is input. However, this embodiment is characterized in that a separate emergency number for indicating a threatening situation, such as kidnapping or hostage-taking, is registered in addition to the password. The emergency number may be made by adding some number to the password at the end of the password. Of course, it is apparent that a card issuing company, or a financial company for managing an Automated Teller Machine (ATM), must know the emergency number, and a system for monitoring the input of the emergency number when the emergency number together with the password is input must be constructed.

That is, when an assailant robs a victim of the card 1 and threatens the victim in order to obtain the password from the victim, the victim gives the assailant the number 25739, obtained by attaching an emergency number (for example, 9) to the end of the normal password (for example, 2573).

Since the number of digits in a password for turning on off the card 1 is not designated to a specific value, such as four or five, the card 1 is turned on and is changed to a usable state, similar to the case where only the original password 2573 is input, if the assailant inputs the number 25739 as a password.

When a number identical to the emergency number 9, set at the time of issuing the card, is input together with the password, the controller 10 of the card 1 activates the magnetic stripe unit while turning on the card 1 so that it is in a usable state, thereby enabling a smart card or a magnetic stripe card terminal to read the emergency number and to transmit an emergency alarm to a card payment authentication center, and causing an emergency alarm to be activated. Accordingly, the location at which a crime occurred, the identity of a victim, the amount of damage, etc. are recognized in real time, so that measures for suppressing the crime can immediately be taken.

What is claimed is:

1. A card having password input keys, comprising:
an input key unit including input keys formed on an edge or a surface of the card, and adapted to turn on/off power of the card, select various functions, and increment or decrement a number;
a main IC chip for interfacing with a smart card terminal;
a controller for storing a password input through manipulation of the input key unit, and outputting a control signal for activating the main IC chip when the stored password is identical to a password input through manipulation of the input key unit for usage of the card;
a switch turned on/off under the control of the controller to connect the controller to the main IC chip, thus activating the main IC chip;
an internal thin film battery for supplying power to drive the controller; and
a display panel for displaying a power state of the card or an input state of the input key unit.

2. The card according to claim 1, wherein the main IC chip or magnetic stripe unit is designed so that a code part for activating an emergency alarm is set in the main IC chip or the magnetic stripe unit, and the controller is operated so that, if a signal requesting transmission of an emergency signal is input together with the password, through manipulation of the input key unit, the controller activates the code part in the main IC chip or the magnetic stripe unit for activating the emergency alarm to a payment center.

3. The card according to claim 1, further comprising a sensor adapted to sense a signal of a smart card terminal or magnetic stripe card terminal and connected to the controller, the controller being operated such that, if the card which is turned on through input of a password identical to the preset password, is passed through a smart card terminal or the magnetic stripe card terminal once, the controller releases the card from the turned-on state, thus preventing repeated payment using the card and duplication of the card.

4. The card according to claim 1, wherein the input key unit comprises a function key for turning on/off power of the card and setting a number displayed in the display panel, up/down keys for incrementing or decrementing a number displayed in the display panel, and a change/delete key for changing or deleting a number displayed in the display panel.

5. The card according to claim 1, wherein each key of the input key unit is a tactile switch or a capacitive membrane switch.

6. A card having password input keys, comprising:
an input key unit including input keys formed on an edge or a surface of the card, and adapted to turn on/off power of the card, select various functions, and increment or decrement a number;
a magnetic stripe unit for storing data information about the card;
a thin film permanent magnet;
a controller for storing a password input through manipulation of the input key unit, and outputting a control signal for activating the magnetic stripe unit when the stored password is identical to a password input through manipulation of the input key unit for usage of the card;
a switch turned on/off under the control of the controller to connect the thin film permanent magnet to the magnetic stripe unit, thus activating the magnetic stripe unit;
an internal thin film battery for supplying power to drive the controller; and
a display panel for displaying a power state of the card or an input state of the input key unit.

7. The card according to claim 6, wherein the main IC chip or magnetic stripe unit is designed so that a code part for activating an emergency alarm is set in the main IC chip or the magnetic stripe unit, and the controller is operated so that, if a signal requesting transmission of an emergency signal is input together with the password, through manipulation of the input key unit, the controller activates the code part in the main IC chip or the magnetic stripe unit for activating the emergency alarm to a payment center.

8. The card according to claim 6, further comprising a sensor adapted to sense a signal of a smart card terminal or magnetic stripe card terminal and connected to the controller, the controller being operated such that, if the card which is turned on through input of a password identical to the preset password, is passed through a smart card terminal or the magnetic stripe card terminal once, the controller releases the card from the turned-on state, thus preventing repeated payment using the card and duplication of the card.

9. The card according to claim 6, wherein the input key unit comprises a function key for turning on/off power of the card and setting a number displayed in the display panel, up/down keys for incrementing or decrementing a number displayed in the display panel, and a change/delete key for changing or deleting a number displayed in the display panel.

10. The card according to claim 6, wherein each key of the input key unit is a tactile switch or a capacitive membrane switch.

11. A card having password input keys, comprising:
an input key unit including input keys formed on an edge or a surface of the card;
a controller for storing a preset information together with a password input through manipulation of the input key unit, and outputting a control signal for displaying the preset information when the stored password is identical to a password input through manipulation of the input key unit for usage of the card;
a display panel driven under control of the controller and adapted to show a power state of the card or an input state of the input key unit, and the preset information, stored in the controller, to the user; and
an internal thin film battery for supplying power to drive the controller.

12. The card according to claim 11, wherein the preset information includes at least one selected from the group consisting of Card Verification Value (CVV), a plurality of number groups required to create a one-time password (OTP) for security in a financial transaction through combination of numbers, a unique identification code of a card, a resident registration number and the name of a card holder.

13. The card according to claim 11, wherein the input key unit comprises a function key for turning on/off power of the card and setting a number displayed in the display panel, up/down keys for incrementing or decrementing a number displayed in the display panel, and a change/delete key for changing or deleting a number displayed in the display panel.

14. The card according to claim 11, wherein each key of the input key unit is a tactile switch or a capacitive membrane switch.

15. A card having password input keys, comprising:
an input key unit including input keys formed on an edge or a surface of the card;
a controller for causing a visual information of a holder of a card to be attached to a surface of the card while storing a password input through manipulation of the input key unit, and for outputting a control signal for displaying the visual information hidden by a screen which is opaque so that the visual information is not visible at normal times and is transparent if the stored password is identical to a password input through manipulation of the input key unit;
the screen maintained in an opaque state when a password is not inputted through manipulation of the input key unit and is transparent if the stored password is identical to a password input through manipulation of the input key unit;
and an internal thin film battery for supplying power to drive the controller and the screen.

16. The card according to claim 15, wherein the screen is Electrochromic Display (ECD) screen which is opaque when current does not flow and is transparent when power is supplied,
and the card further comprising a display panel driven under control of the controller and adapted to show a power state of the card or an input state of the input key unit.

17. The card according to claim 15, wherein the input key unit comprises a function key for turning on/off power of the card and setting a number displayed in the display panel, up/down keys for incrementing or decrementing a number displayed in the display panel, and a change/delete key for changing or deleting a number displayed in the display panel.

18. The card according to claim 15, wherein each key of the input key unit is a tactile switch or a capacitive membrane switch.
